(19) United States
(12) Patent Application Publication
(10) Pub. No.: US 2012/0031146 A1
(43) Pub. Date: Feb. 9, 2012

(54) Method of fabricating randomly-colorized glass vessels

(75) Inventor: Michael Arnold Albert Kramer, Mexico City (MX)

(73) Assignee: Grupo Pavisa, S.A. de C.V.

(21) Appl. No.: 13/136,472

(22) Filed: Aug. 2, 2011

Related U.S. Application Data
(60) Provisional application No. 61/463,546, filed on Feb. 19, 2011.

(30) Foreign Application Priority Data
Aug. 4, 2010 (MX) MX/E/2010/048026

(51) Int. Cl. C03C 1/06; C03B 9/14; C03B 9/30

(52) U.S. Cl. 65/77; 65/68

(57) ABSTRACT

A method of fabricating a randomly-colorized glass vessel includes gathering an initial gob of molten primary glass. A quantity of secondary-glass particles is introduced into the initial gob in order to form a particle-containing gob. The secondary-glass particles are made from a secondary glass that contrasts in color with the primary glass. The particle-containing gob is then heated sufficiently to melt the secondary-glass particles and create flows of the secondary glass within the primary glass. Once the desired flows have been created, the gob of primary and secondary glass is introduced into a vessel-defining mold. The mold is sealed and a quantity of gas is injected into the mold in order to form the gob of primary and secondary glass into a vessel.

### U.S. PROVISIONAL AND FOREIGN APPLICATION PRIORITY CLAIMS

Priority based on Provisional Application Ser. No. 61/463,546 filed Feb. 19, 2011, and entitled “METHOD OF FABRICATING RANDOMLY-COLORIZED GLASS OBJECTS” is claimed. Priority is also claimed in Mexican Patent Application Folio No. MX/E/2010/048026 filed Aug. 4, 2010 and entitled APLICACION DE COLOR DE MANERA IRREGULAR PARA OBJECTOS DE VIDRIO Y CRISTAL. The entirety of the disclosures of each of the previous applications, including the drawings, is incorporated herein by reference as if set forth fully in the present application.

### BACKGROUND

The formation of glass into useful and artistic objects dates to at least the 4^{th} Century BCE. Among the established techniques for forming glass are flow-molding, press-molding and hand-blowing. Hand-blown glass objects are admired for the artistry and skill required to produce them, and the uniqueness of each piece so produced. One effect traditionally produced by glass-blowing artisans is the infusion of random flows of disparately colored glasses in finished products. The randomness of such colorization signifies artistry, skill and uniqueness. However, the very nature of the hand-blowing process renders hand-blown pieces expensive and impractical for use as containers for all but the highest-end products such as fine perfumes and select alcoholic beverages.

Contrasting with the artistry associated with hand-blown glass objects is the rapid mass production of strictly utilitarian objects such as window panes and beverage bottles. Among the goals of manufacturing vessels such as drinking glasses and beverage bottles are rapid reproducibility and uniformity of appearance among units. Of particular importance is uniformity among units is physical dimensions such opening shape and size in order to facilitate the use of standardized lids, plugs or caps as closures. Accordingly, in the modern era, glass vessels are largely produced by strictly-controlled automated hot pressing and blowing processes. Such processes have the advantage of being relatively inexpensive and invariant, but result in products lacking uniqueness and artistry.

Accordingly, a need exists for a method of incorporating, within a glass vessel, the unique feature of random colorization in a manner that facilitates ready and reliable reproducibility of predetermined physical dimensions.

### SUMMARY

Implementations of the present invention are generally directed methods of fabricating glass vessels incorporating random colorization by causing the flow of a molten secondary glass within a molten primary glass. Although not so limited in scope, among the glass vessels of particular interest are drinking glasses, cups, bowls, decanters, vases, and selectively closeable bottles.

In accordance with an illustratively implemented method, an initial gob of molten primary glass of a first color is gathered. In a typical version, the initial gob is removed from a reservoir or vat of molten glass within glass furnace by gathering it about a distal end of an elongated gathering implement such as a rod, tube or gathering iron, by way of example. In some versions, the distal end of the gathering implement includes a ceramic ball about which molten glass is gathered. A quantity of secondary-glass particles (e.g., frit) of a second color is then introduced into the initial gob in order to form a particle-containing gob. Illustratively, the particles are introduced by dipping and rolling the initial gob in a container (e.g., a tray) of secondary-glass particles. Among alternative versions, the particles vary in size from fine powder or dust to relatively macroscopic shards or fragments. Moreover, since it is a principal objective of various implementations to create randomized color effects, the secondary glass from which the secondary-glass particles are formed contrasts in color with the primary glass. For purposes of conceptualizing the desired color contrast, it is to be understood that “transparent” or “clear” is regarded as a color throughout the present description and the claims appended hereto.

The particle-containing gob is heated such that the secondary-glass particles melt and the secondary glass flows within the primary glass. Randomized flow effects are facilitated by the selective rotation and axial reorientation of the gathering implement. In at least one illustrative implementation, the gob of primary and secondary glass is introduced into a reservoir (e.g., a vat inside a glass furnace) of the primary glass in order to cover the gob of primary and secondary glass with an additional “layer” or “coating” of primary glass. The gathering implement is manipulated in order to allow heat from the second gather to penetrate the first gather of primary and secondary glass and cause the glasses to “flow through” one another. The objective in not to create a single, homogenously-blended color, but to retain the visibility of the disparate colors while having the secondary glass become molten and flow through the primary glass in order to create randomized flow patterns.

Depending on the type of vessel being fabricated, the gob of primary and secondary glass is sequentially introduced into one or more molds. In accordance with one implementation, the gob of primary and secondary glass is introduced into a shaping cavity defined by the interior walls of a multi-piece pre-form mold. More specifically, in one such implementation, the gathering implement is oriented at an angle sufficiently steep, relative to horizontal, to facilitate the gob's flowing, under the force of gravity, through an input opening defined in the upper portion of the pre-form mold. With the gob in the pre-form mold, the top opening is sealed and a quantity of gas (e.g., air) is injected into the pre-form mold in order to form the gob of primary and secondary glass into a pre-form vessel. After removal from the pre-form mold, the vessel perform is introduced into finish mold and a quantity of gas (e.g., air) is injected into the finish mold in order to form the pre-form vessel into a finished vessel.

In fabricating a more complex glass object, such as a bottle including a neck, the use of a pre-form mold facilitates intermediate shaping, thereby obviating logistical difficulties and diminished quality attendant to the single-mold formation of a shapeless gob into the final shape desired. However, it is to be understood that, absent explicit limitations to the contrary, within the scope and contemplation of the invention as defined in the appended claims are versions involving only a single molding step. Moreover, it will be generally appreciated that implementations prescribing more than two molding steps are also within the scope of the invention as defined in the claims. More specifically, even in implementations involving three or more molding steps, at least one such step is regarded as a pre-forming step involving a pre-form mold, while at least one other step is regarded as a finish molding step involving a finish mold.

In alternatively implemented versions, apparatus controlled by a programmable computer are variously utilized in the performance one or more steps. For instance, the use of a computer-controlled pneumatic injector is particularly useful in ensuring that the quantity and pressure of gas injected into the mold is appropriate, precise and selectively tunable. Additionally, at least one mold can be opened and closed by computer-controlled pneumatics, hydraulics or motor-actuated linkages. While human involvement is integral to the implementation of some versions, particularly at the gob-gathering, particle infusion, and heating stages—where an artisan's vision and skill might be desired—in alternative versions, even one or more of the steps prior to introduction of the gob into a mold is performed by computer-controlled apparatus.

Representative, non-limiting implementations are more completely described and depicted in the following detailed description and the accompanying drawings.

### BRIEF DESCRIPTION OF THE DRAWINGS

FIG. 1 depicts a gathered gob of molten primary glass being extracted from a glass furnace;

FIG. 2 shows the generally ellipsoidal gob of FIG. 1 being rolled in a tray of secondary-glass particles in order to form a particle-containing gob;

FIG. 3 illustrates the heating of the particle-containing gob in order to melt the secondary-glass particles and form a molten gob of primary and secondary glass;

FIG. 3A shows the addition primary glass over the gob of FIG. 3;

FIG. 4 shows the gob of primary and secondary glass being deposited into a closed vessel-defining pre-form mold;

FIG. 5A depicts the opened pre-form mold and the injection of gas to force the molten gob to assume a non-final shape defined by the pre-form mold, although the pre-form mold would not be open when gas is injected;

FIG. 5B shows the non-finally-shaped pre-form vessel after removal from the pre-form mold;

FIG. 5C depicts the non-finally-shaped pre-form vessel situated in an open finish mold;

FIG. 6 shows the finish mold of FIG. 5C in a closed position so that gas can be introduced to finalize the basic shape of the pre-form vessel of FIGS. 5A-5C;

FIG. 6A depicts the finish mold of FIGS. 5C and 6 in an open position with the finally-shaped pre-form vessel still disposed therein; and

FIG. 7 shows a finished vessel in the form of a bottle being introduced into a continuous annealer.

### DETAILED DESCRIPTION

The following description of methods of fabricating a glass vessel with random colorization, and of glass vessels fabricated in accordance therewith, is demonstrative in nature and is not intended to limit the invention or its application of uses. The various implementations, aspects, versions and embodiments described in the summary and detailed description are in the nature of non-limiting examples falling within the scope of the appended claims and do not serve to maximally define the scope of the claims.

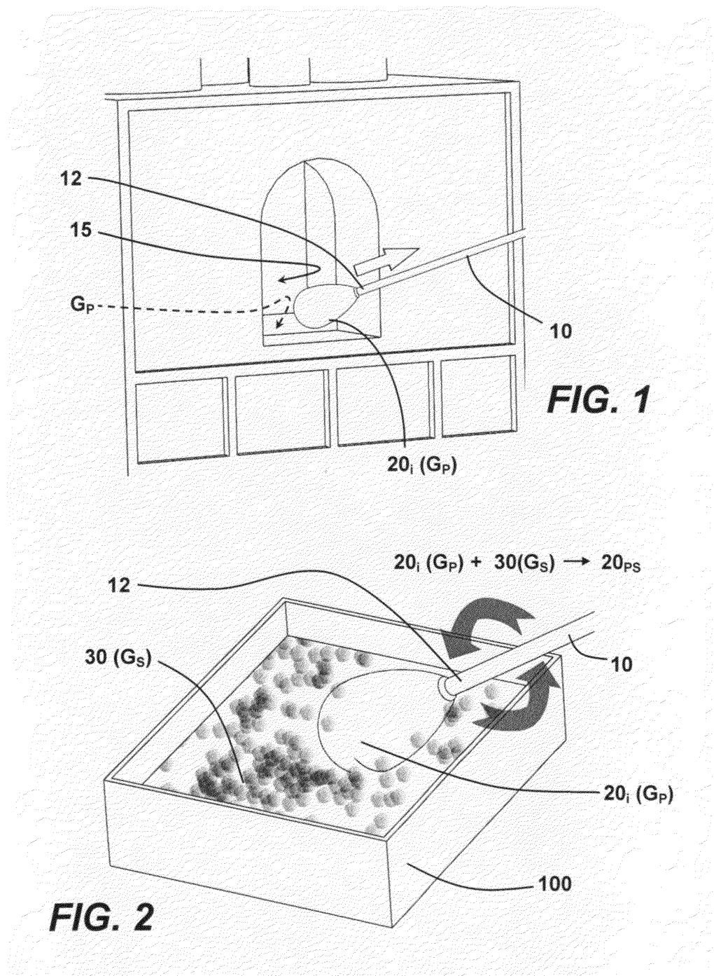

In conjunction with FIGS. 1 through 7, there are described alternative illustrative methods of fabricating a randomly-colorized glass vessel. With initial reference to FIG. 1, an initial gob 20ᵢ of molten primary glass G_{P} is gathered around the distal end 12 of an elongated gathering implement 10 and extracted from a furnace 15. The gathering implement 10 is manipulated in order to give the initial gob 20ᵢ a generally ellipsoidal shape.

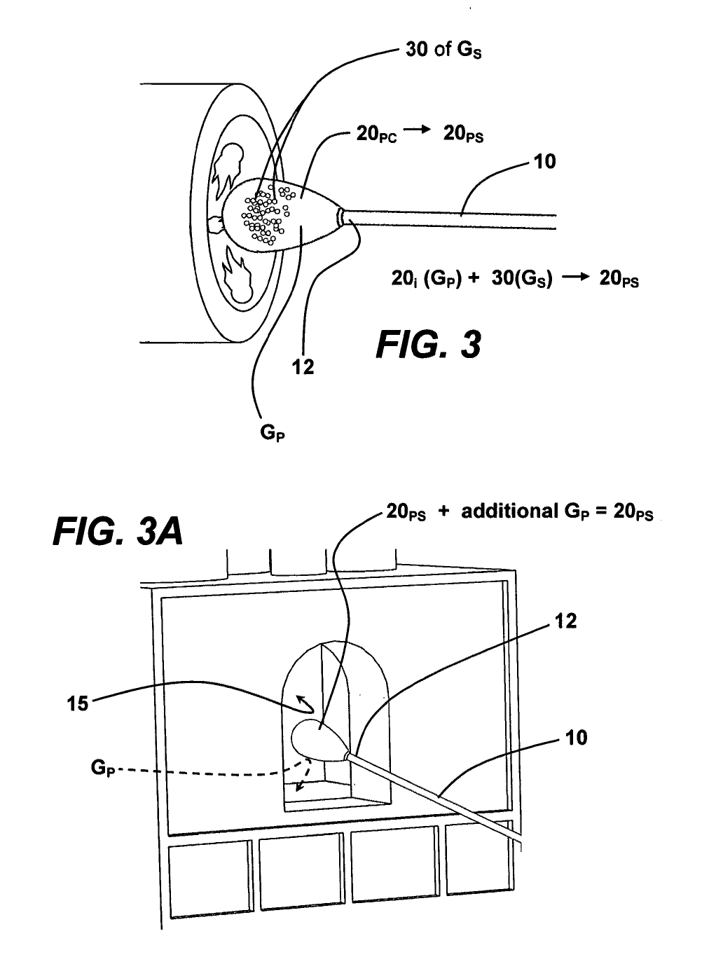

A shown in FIG. 2, the initial gob 20ᵢ is dipped and rolled in a tray 100 containing secondary-glass particles 30 made from secondary glass G_{S}. Depending on the desired effects, the initial gob 20ᵢ is rolled to a greater or lesser extent in the secondary-glass particles 30 to form a particle-containing gob 20_{PC}, a completed version of which is shown in FIG. 3. The secondary-glass particles 30 associated with alternative implementations range in size from glass dust to macroscopic shards or fragments. It is noted, however, that smaller particles 30 will heat and melt more quickly than larger particles 30 of the same secondary glass G_{S}. The secondary glass G_{S} contrasts in color with the primary glass G_{P}. Moreover, in some versions, a plurality of secondary glasses G_{S} of disparate colors is used.

With a desired quantity of secondary-glass particles 30 introduced into the initial gob 20ᵢ, the particle-containing gob 20_{PC} is heated, as shown in FIG. 3, in order to melt the secondary glass G_{S} and form a gob 20_{PS} of primary and secondary glass. Randomized molten flows of secondary glass G_{S} are induced within the molten primary glass G_{P} by the selective manipulation of the gathering implement 10. Reheating of the gob 20_{PS} of primary and secondary glass is sometimes necessary to complete the melt and flow process.

One illustrative implementation prescribes covering at least a portion of the gob 20_{PS} of primary and secondary glass with additional primary glass G_{P}. For illustrative purposes, FIG. 3A indicates the addition of primary glass G_{P} by re-inserting the distal end 12 of the gathering implement 10 into the furnace 15 from which the initial gob 20ᵢ of primary glass G_{P} was withdrawn. Adding molten primary glass G_{P} over the outside of the gob 20_{PS} of primary and secondary glass variously facilitates melting of the secondary-glass particles 30 and the flow of melted secondary glass G_{S} more toward the center of the gob 20_{PS} of primary and secondary glass.

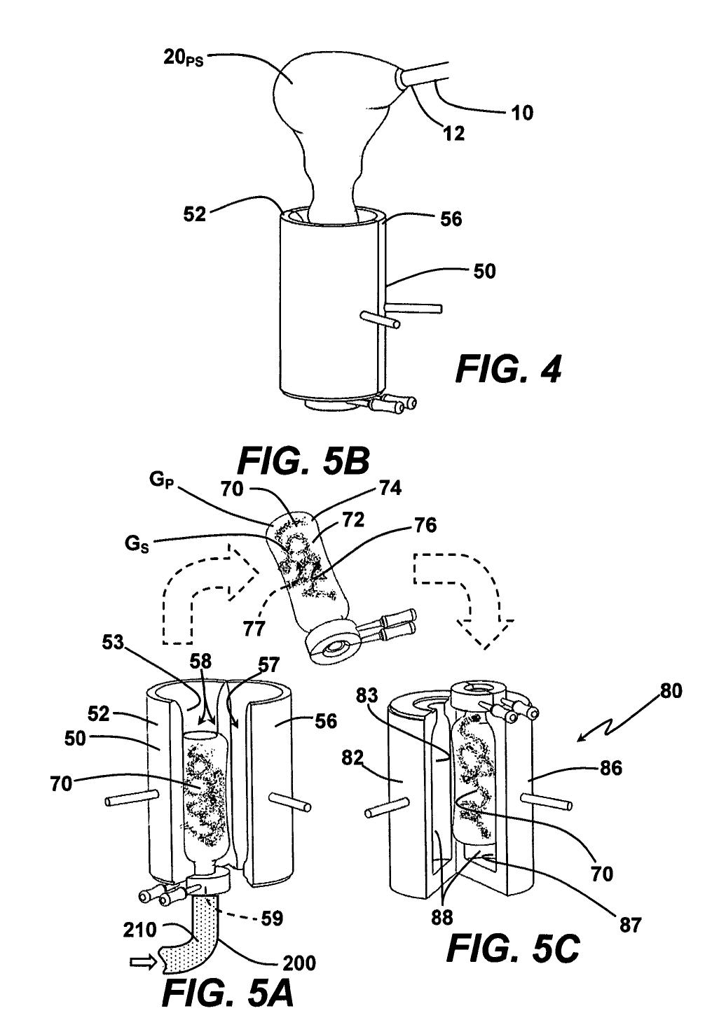

Following the heat and flow process, an illustrative, non-limiting implementation prescribes a two-stage molding process, including, as shown in FIG. 4, the introduction of the molten gob 20_{PS} of primary and secondary glass into a pre-form mold 50. With additional reference to FIG. 5A, the illustrative pre-form mold 50 first shown in FIG. 4 includes first and second mold portions 52 and 56 with, respectively, first and second interior walls 53 and 57. When the first and second mold portions 52 and 56—which are hingedly joined in the example depicted—are brought into mutual contact, the first and second interior walls 53 and 57 define an internal pre-shaping cavity 58. In the illustrative version depicted, the pre-shaping cavity 58 is configured to define a pre-form vessel 70.

With continued reference to FIGS. 4 and 5A, with the molten gob 20_{PS} deposited in the pre-form mold 50, a pneumatic injector 200 injects a quantity of gas 210 into the pre-form mold 50 through an opening 59. The internal gas pressure is elevated sufficiently to form the gob 20_{PS} into a pre-form vessel 70. While the formation of the gob 20_{PS} into a pre-form vessel 70 is shown in FIG. 5A with the pre-form mold 50 depicted in an open position, this is only to facilitate explanation; it is to be understood that the introduction of gas 210 into the pre-form mold 50 actually occurs while the first and second mold portions 52 and 56 are in mutual contact (i.e., while the pre-form mold 50 is closed, as in FIG. 4).

When the pre-form vessel 70 is sufficiently cool and “self-supporting” to retain its basic shape, the pre-form mold 50 is opened and the pre-form vessel 70 is removed, as shown in, respectively, FIGS. 5A and 5B. The illustrative pre-form vessel 70 of FIG. 5B has a pre-form vessel wall 72 defining a pre-form vessel exterior surface 74 and a pre-form vessel interior surface 76 defining a pre-form vessel cavity 77. Moreover, the pre-form vessel wall 72 includes “swirls” of secondary glass G_{S} embedded within the primary glass G_{P}. As shown in FIG. 5C, the heated pre-form vessel 70 is transferred from the pre-form mold 50 to a finish mold 80. The illustrative finish mold 80 of FIG. 5C includes first and second mold pieces (or portions) 82 and 86 having, respectively, first and second inside walls 83 and 87. When the first and second mold pieces 82 and 86 are urged into mutual contact to seal the finish mold 80, the first and second inside walls 83 and 87 define an internal finish-shaping cavity 88.

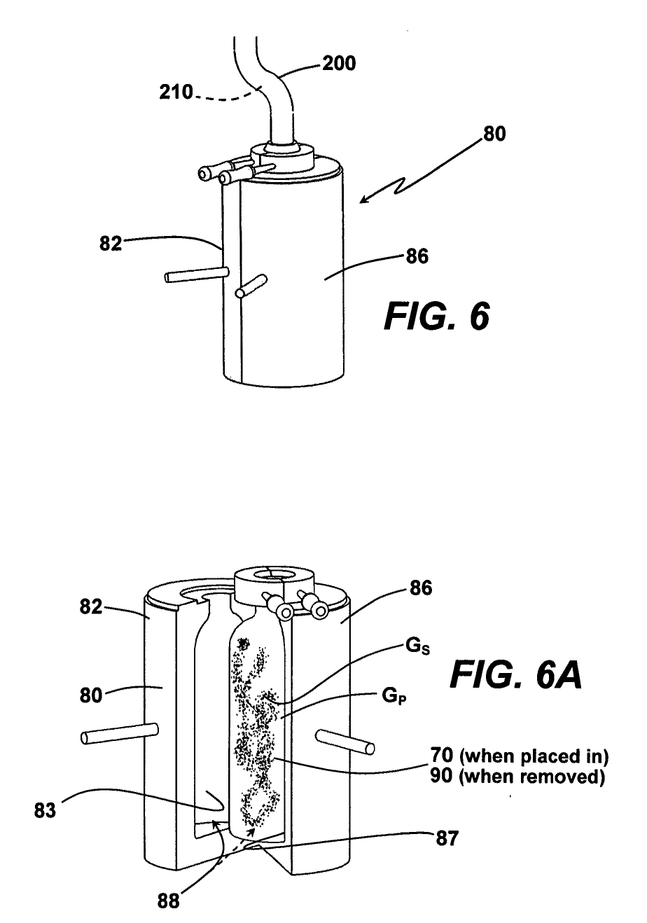

As shown in FIG. 6, in a manner analogous to that associated with shaping in the pre-form mold 50, a quantity of gas 210 is injected into the finish mold 80, and into the pre-form vessel cavity 77, through a pneumatic injector 200 in order to impart to the pre-form vessel 70 its final basic shape and form it into what is subsequently regarded as a finished vessel 90. After shaping in the finish mold 80, the finish mold 80 is opened, as shown in FIG. 6A, and the finished vessel 90 is removed.

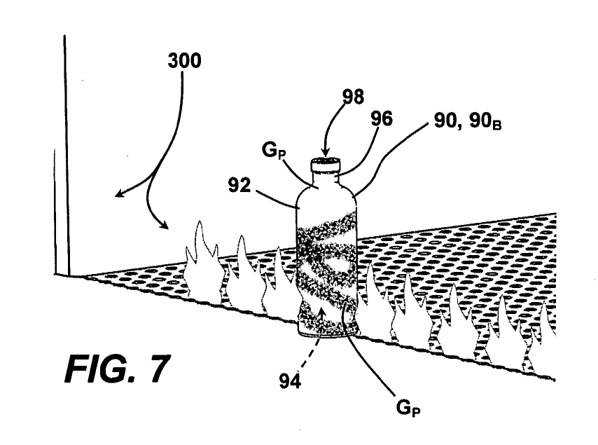

Referring to FIG. 7, an illustrative implementation calls for the processing of the finished vessel 90 through an annealer 300 in order to cool the glass in a controlled manner and prevent internal stresses that might cause the glass to crack. The illustrative finished vessel 90 shown in FIG. 7 is a bottle 90_{B} having a main body 92 defining an internal storage cavity 94 and a neck 96 depending from the body 92. As with the pre-form vessel 70 shown in FIG. 5B, the bottle 90_{B} includes a randomized pattern (“swirls,” in this case) of secondary glass G_{S} embedded within the primary glass G_{P}. The neck 96 is narrow relative to the main body 92 and has a neck opening 98 (or channel) extending therethrough that renders the storage cavity 94 in fluid communication with the exterior of the bottle 90_{B}. It will be appreciated that the formation of a relatively narrow neck 96 might best be performed in a multi-stage molding process. This is particularly true when the neck 96 and the neck opening 98 must be fabricated within “tight” or relatively unforgiving tolerances, such as when the bottles 90_{B} being produced are to be sealed by standardized closures such as caps or plugs (not shown).

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A method of fabricating a randomly-colorized glass vessel of predetermined shape, the method comprising:
gathering an initial gob of molten primary glass;
introducing into the initial gob a quantity of secondary-glass particles in order to form a particle-containing gob, the secondary-glass particles being made from a secondary glass contrasting in color with the primary glass;
heating the particle-containing gob such that the secondary-glass particles melt and the molten secondary glass flows within the primary glass; and
introducing the gob of primary and secondary glass into a mold in order to form the gob of primary and secondary glass into a vessel of predetermined shape.

2. The method of claim 1 wherein the vessel is a bottle having a main body defining an internal storage cavity and a neck depending from the body, the neck being narrow relative to the main body and having an opening extending therethrough that renders the storage cavity in fluid communication with the exterior of the bottle.

3. A method of fabricating a randomly-colorized glass vessel comprising the steps of:
gathering an initial gob of molten primary glass;
introducing into the initial gob a quantity of secondary-glass particles in order to form a particle-containing gob, the secondary-glass particles being made from a secondary glass contrasting in color with the primary glass;
heating the particle-containing gob such that the secondary-glass particles melt and the secondary glass flows within the primary glass;
introducing the gob of primary and secondary glass into a mold;
injecting a quantity of gas into the mold in order to form the gob of primary and secondary glass into a vessel.

4. The method of claim 3 wherein the mold is configured to define a neck portion with a neck opening in the vessel.

5. The method of claim 4 wherein the vessel is a bottle.

6. A method of fabricating a randomly-colorized glass vessel comprising the steps of:
gathering an initial gob of molten primary glass;
introducing into the initial gob a quantity of secondary-glass particles in order to form a particle-containing gob, the secondary-glass particles being made from a secondary glass contrasting in color with the primary glass;
heating the particle-containing gob such that the secondary-glass particles melt and the secondary glass flows within the primary glass;
introducing the gob of primary and secondary glass into a pre-form mold;
injecting a quantity of gas into the pre-form mold in order to form the gob of primary and secondary glass into a pre-form vessel having at least one pre-form vessel wall defining a pre-form vessel cavity;
removing the pre-form vessel from the pre-form mold;
introducing the pre-form vessel into a finish mold; and
injecting a quantity of gas into the pre-form vessel cavity within the finish mold in order to form the pre-form vessel into a finished vessel.

7. The method of claim 6 wherein at least the finish mold is configured to define a neck portion with a neck opening in the finished vessel.

8. The method of claim 7 wherein the finished vessel is a bottle.
